(19) United States
(12) Patent Application Publication
(10) Pub. No.: US 2004/0040314 A1
(43) Pub. Date: Mar. 4, 2004

(54) Gas turbine and spacer member for the use therein

(75) Inventors: Nobuhiro Isobe, Tokyo (JP); Katsuhiko Sagae, Tokyo (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd.

(21) Appl. No.: 10/653,917

(22) Filed: Sep. 4, 2003

(30) Foreign Application Priority Data
Sep. 4, 2002 (JP) 2002-258372

(51) Int. Cl. F02C 3/04

(52) U.S. Cl. 60/805

(57) ABSTRACT

In a gas turbine, in which a compressor and a turbine are connected by means of a distant piece, the distant piece and a turbine first-stage disk 1 are connected by means of a joint portion. On the distant piece is formed a projection portion, and a spacer is held by means of a spigot portion. Thin portion is formed on an outer diameter side of the spacer, and is in contact with a fin of a turbine disk through a seal member. The turbine disk, the distant piece and the spacer define a cavity.

### BACKGROUND OF THE INVENTION

The present invention relates to a gas turbine and a seal member for use therein, and in particular to a gas turbine and a spacer member for use therein, in which a compressor constructing the gas turbine uses a part of compressed air for cooling a turbine rotor blade thereof.

An example of a conventional cooling apparatus for a gas turbine is described, for example, in Japanese Patent Laying-Open No. 2001-3703 (2001) <JP-A 2001-3073>. In the gas turbine described in this publication, for the purpose of cooling the turbine rotor blades, a cylindrical member is inserted into a gap, which is defined by neighboring rotor wheels, and thereby a coolant gas is guided to a dove-tail portion of each of the rotor blades.

Other example of a conventional gas turbine is described, for example, in Japanese Patent Laying-open No. Hei 11-22403 (1999) <JP-A 11-22403>. Within the gas turbine structure described in this publication, for the purpose of cooling the turbine rotor blades, a sealing air is guided into a cavity formed in front of a rotor disk, so as to prevent the compressed air from leaking out from a middle shaft, while a portion thereof is guided into a main current to be the sealing air for inhibiting the leakage between the turbine stator blade and the turbine rotor blade, and the rest thereof is guided from an inlet of rotor blade air for cooling the rotor blades. And thereafter, it cools down the rotor blades and is mixed up with the main current. Further, separating from such sealing air for the middle shaft, a cooling air that is adjusted in flow-rate thereof is supplied into the cavity, for the purpose of guiding a desired amount of cooling air for the rotor blades. Further, the similar gas turbine is also described in Japanese PCT Publication No. 2001-527178 (2001), for example.

Within such the gas turbine as described in the Japanese Patent Laying-Open No. 2001-3703 (2001) mentioned above, although it is possible to supply the cooling air to the rotor blades with certainty, however consideration is not fully paid upon a case where a distant piece and a rotor disk are connected by means of a joint portion for achieving small-sizing of the gas turbine. Namely, there is no description about a case, in particular, where it is impossible to project an outer-periphery side of the distant piece into the turbine side, due to convenience of machining the joint portion, for example.

Also, with such the gas turbine as is described in the Japanese Patent Laying-Open No. Hei 11-22403 (1999) mentioned above, however since the sealing gas leaks into the main current gas, always, though being very small in the amount thereof, therefore an amount of the sealing gas comes up. For this reason, an efficiency of the compressor comes down if using the air compressed by the compressor for that gas sealing, and as a result thereof, an output of the gas turbine is reduced, as a whole.

Further in such the gas turbine as is described in the Japanese PCT Publication No. 2001-527178 (2001) mentioned above, for improving the property of anti-centrifugal forces, a fin is provided on a cover, thereby preventing the combustion gas from leaking into the axial side. However, the provision of the fin on the cover brings about the necessity of releasing the large centrifugal stress, which is caused on the fin portion thereof, thereby resulting in complexness in the structure of the cover.

### BRIEF SUMMARY OF THE INVENTION

According to the present invention, for dissolving such the drawbacks of the conventional arts mentioned above, an object thereof is to provide a gas turbine, in which the rotor turbines can be cooled with the simple structure thereof. Other object, according to the present invention, is to provide the structure for cooling the turbine rotor blades of the gas turbine, effectively.

For accomplishing the objects mentioned above, according to the present invention, there is provided a gas turbine, comprising: a turbine having a plural number of rotary blades attached on a disk; a compressor; and a distant piece for connecting between said turbine and said compressor, whereby a portion of compressed air from said compressor is used for cooling the rotary blades of said turbine, wherein a spacer member is attached on one end of said distant piece, in axial direction thereof, for forming a cooling passage by means of the compression air between said disk. And, the gas turbine, as described in the above, preferably further comprises a seal member provided for sealing between said spacer member and said disk.

For accomplishing the objects mentioned above, according to the present invention, there is also provided a gas turbine, comprising: a turbine having a plural number of rotary blades attached on a disk; a compressor; and a distant piece for connecting between said turbine and said compressor, wherein a portion of compressed air from said compressor is used for cooling the rotary blades of said turbine, wherein said disk has a ring-like fin extending into a side of said compressor on a periphery side being inner than implantation portions of the rotary blades; a spacer member is provided at an end portion of said distant piece at a side of the turbine; and a cavity is formed between said distant piece and said disk by bringing said fin and said spacer member into contact with.

Also, in the gas turbine as described in the above, preferably, said disk has a plural number of cooling holes, being formed at a distance therebeteween in a direction of periphery thereof, and those cooling holes are connected to said cavity and said rotary blades, or wherein other cooling holes (cooling air passages) are provided for guiding a portion of the gas compressed in said compressor into said cavity. And, in the gas turbine as described in the above, said cooling holes may be formed only in a disk of a first-stage thereof in a case where said turbine is made up with a plural number of stages. Further, in the gas turbine as described in the above, preferably, a cooling passage is formed in said rotary blade, connecting to said cooling hole.

Further for accomplishing the objects mentioned above, according to the present invention, there is also provided a spacer member, being fixedly attached on an end portion of a distant piece for connecting a compressor and a turbine, comprising a cavity formed between said distant piece and a disk for use of turbine rotary blades. In the spacer member as described in the above, preferably said spacer member is disposed so that an end surface thereof is in contact with a ring-like fin, being formed on said disk for use of turbine rotary blades in an inner side than implanting portion of the rotary blades thereof and extending into a side of said compressor, through a seal member. Also, in the spacer member as described in the above, preferably the side end surface at the compressor is a plane when said spacer member is fixed onto said distant piece, and thickness in axial direction of a portion contacting with the ring-like fin formed on said disk for use of turbine rotary blades is thinner than that in axial direction of a portion connecting to said distant piece.

### BRIEF DESCRIPTION OF THE SEVERAL VIEWS OF THE INVENTION

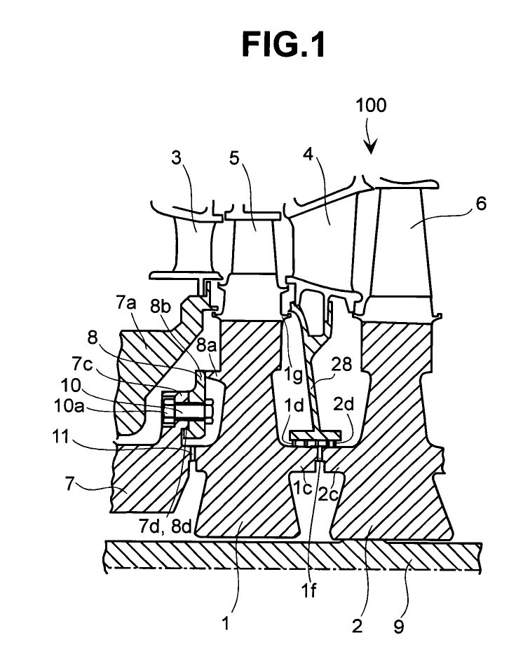

FIG. 1 is a vertical cross-section view of a principle portion of a gas turbine, according to an embodiment of the present invention;

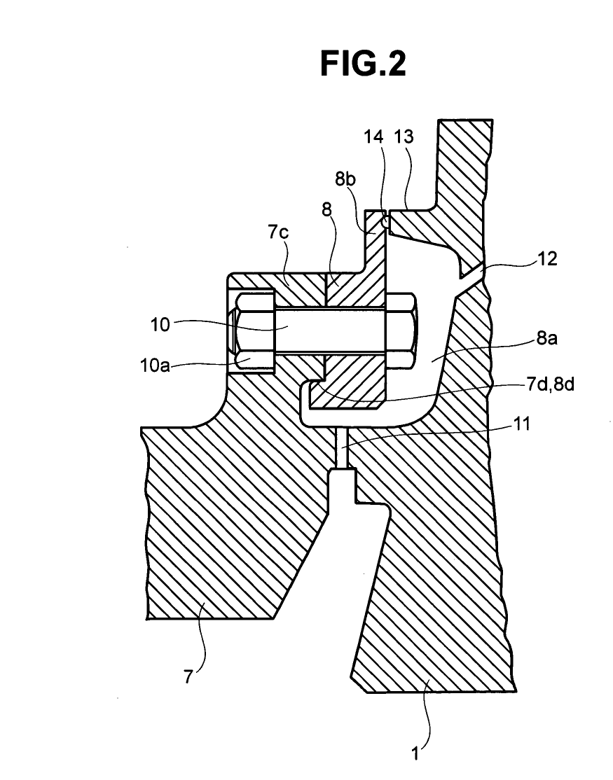

FIG. 2 is an enlarged cross-section view on periphery of a space applied in the embodiment shown in FIG. 1;

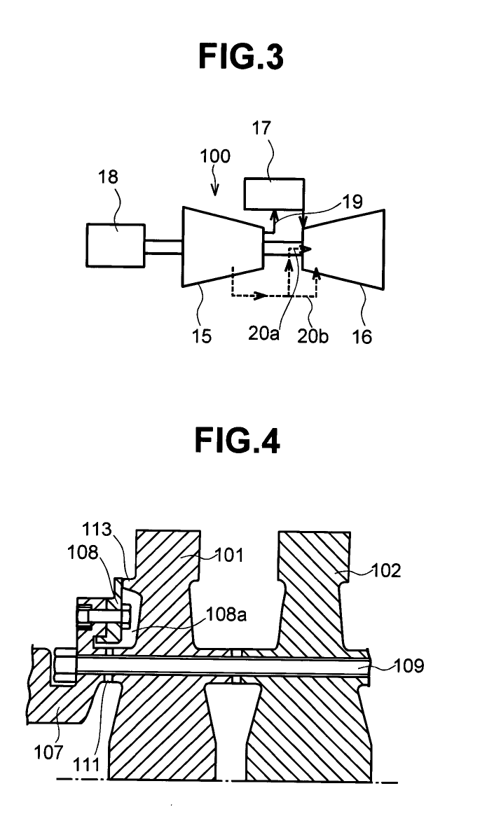

FIG. 3 is a block diagram of the gas turbine according to the present invention; and

FIG. 4 is a vertical cross-section view of the principle portion of the gas turbine, according to other embodiment of the present invention.

### DETAILED DESCRIPTION OF THE INVENTION

Hereinafter, explanation will be given on one embodiment, according to the present invention, by referring to the drawings attached. FIG. 3 is a block diagram of the gas turbine. In the gas turbine 100, a turbine 16 is rotated through high-temperature combustion gas, as a working fluid thereof, thereby driving a power generator 18. While guiding an air compressed by a compressor 15 into a combustor or burner 17, a fuel is introduced within the combustor 17, and it is ignited, then the high-temperature combustion gas can be obtained. The combustion gas obtained is guided into the turbine 16, rotating in synchronism with the compressor 15, through a flow passage 19. Power generated by the turbine 16, which is rotationally driven through the combustion gas, is used for driving a power generator 18 and the compressor 15.

In the gas turbine 100, being constructed in such the structure, a cooling air is extracted from a stage on the way of the compressor 15, for the purpose of cooling the turbine blades, etc. A part of this extracted cooling air is guided into the turbine 16, passing through a flow passage 20a, which is formed in a rotary shaft portion for connecting between the compressor 15 and the turbine 16. The rest of the cooling air is guided into the turbine 16, directly, for the purpose of cooling the stator blades, passing through a flow passage 20b. In the gas turbine described herein, according to the present embodiment, the turbine 16 and the compressor 15 are combined in one body, for transmission of power. For the purpose of achieving this connection between them, a distant piece is used. A manner of this is shown in FIG. 1.

FIG. 1 is a vertical cross-section on periphery of the connection portion between the compressor 15 and the turbine 16. The compressor, not shown in this figure, is connected to one side-end of the distant piece 7. Thus, by means of a joint portion 11 formed at the other side-end of the distant piece 7 in the axial direction thereof, the distant piece 7 is connected to a turbine first-stage disk 1, being disk-like in the shape thereof. The turbine first-stage disk 1 has ring-like double projections, which are formed on a front-side surface; i.e., on the compressor side thereof. A tip of the ring-like projection 1b on an inner-diameter side defines the joint portion 11. The projection on an outer-diameter side is a fin 13, and it is in contact with a spacer 8, which will be mentioned later. On a rear-side surface of the turbine first-stage disk is formed a ring-like projection 1c, and also on an upper surface of this ring-like projection 1c is formed a labyrinth seal 1d.

On the rear-side projection 1c of the turbine first-stage disk 1 is formed a joint portion 1f for connection with a ring-like projection 2c formed on a front surface of a turbine second-stage side disk 2. Also on the outer periphery surface of the projection 2c of this second-stage side disk is formed a labyrinth seal 2d. On outer periphery sides of the turbine first-stage disk 1 and the turbine, second-stage disk 2 are implanted a plural number of blades, respectively, in the circumferential direction thereof at almost equal distance therebetween. At a front side of the axial direction of first rotor blades 5, a plural number of blades, which are disposed at a distance in the circumferential distance thereof, are fixed on a casing, thereby forming first-stage stator blades 3. Between the first-stage rotor blades 5 and the second-stage rotor blades, in the similar manner, also a plural number of blades are fixed on the casing at a distance in the circumferential direction thereof, thereby forming second-stage stator blades 6.

On an inner periphery side of the first-stage stator blades 3 lies a member 7a, having a seal portion for preventing the combustion gas passing through the first-stage stator blades from leaking into an axial side thereof, extending up to a side of the compressor. On an inner periphery side of the second-stage stator blades 4, also for the purpose of preventing the combustion gas passing through the first-stage rotor blades 5 from leaking into the axial side thereof, a seal plate 28 (i.e., a diaphragm) is fixed on the second-stage stator blades, one end of which forms a seal portion with a sealing projection 1g formed on the rear-side surface of the turbine first-stage disk 1, while other end of which forms seal portions between the turbine first-stage disk 1 and the labyrinths 1c and 2c of the turbine second-stage disk 2.

A joint portion 11 is formed on the distant piece 7, on an end surface at a side of the turbine. On a side of the compressor in the axial direction thereof, being nearer than this joint portion 11, a spacer attachment portion 7c is formed extending to an outer diameter side thereof. Onto this attachment portion 7c is fitted a spacer 8 through the faucet or spigot joint. While the spacer is fixed on the distant piece 7 by means of the bolt 10 and the nut 11, an end surface of the spacer 8 at the side of the turbine first-stage disk 1 defines a vertical plane. The distant piece 7, as well as, the turbine first-stage disk 1, the turbine second-stage disk 2 and the compressor portions not shown in the figure, are fixed by means of a stacking bolt 9, in such a manner that they pile up on the inner periphery side thereof.

By the way, the turbine rotor blade, being put directly in the combustion gas, operates under high-temperature environment, therefore it is necessary to keep the shape and reliability thereof. For the purpose of improving an efficiency of the gas turbine, it is preferable to use the combustion gas, being high in the gas temperature thereof. As a result thereof, the high-temperature combustion gas flows into the first-stage blades 5, therefore a flow passage for a cooling air is formed, in an inside of each of the blades building up the first-stage rotor blades 5. However, since the turbine blades building up the first-stage rotor blades are implanted onto the turbine first-stage disk 1, a cooling-air hole is formed in the number of the blades. The cooling air is extracted from an appropriate stage of the compressor where the air has the necessary temperature and the pressure. And, the cooling air is guided from the inner periphery side of the distant piece 7 into the turbine first-stage disk 1, and it reaches to the first-stage rotor blade 5 from a cooling-air hole 12 of the turbine first-stage disk 1. For the purpose of sending the cooling air to each blade, effectively, a cavity is constructed in a periphery of a guidance hole of the cooling air of the turbine first-stage disk 1. However, in the present embodiment, the joint portion 11 is commonly used as the guidance hole for the cooling air.

Detailed view on the periphery of the spacer 8 is shown in FIG. 2. The cooling-air hole 12 for guiding the cooling air onto the turbine first-stage disk 1 is provided opposing to the spacer 8. As was mentioned in the above, the spacer 8 is jointed to the distant piece 7 through the bolt 10. Since the spacer 8 is a part of the rotary body, for ensuring reliability against axial vibration thereof when being installed, the rotary axis of the spacer 8 is made to be coincident with the rotary axes of the turbine disks 1 and 2, on which the rotor blades 5 and 6 are implanted. For that purpose, the faucet or spigot joint is adopted on the attachment surface between the spacer 8 and the distant piece 7. The diameter of the spigot joint portion of the spacer 8 of the convex side is a little bit larger than that of the distant piece 7 of the concave side. When installing the rotor, the distant piece 7 is heated or the spacer 8 is cooled, and then they are fitted. Due to this positioning and the bolt joint, the distant piece 7 and the spacer 8 are unified tightly, in one body, thereby enabling to improve the reliability as to be the rotary body.

The spacer 8 makes up a cavity 8a for guiding the cooling air to the blades implanted on the turbine first-stage disk 1 with high efficiency. For building up the cavity 8a, a fin 13 is formed on the turbine first-stage disk 1, while being in contact with the spacer 8, thereby forming the cavity 8a between the front surface of the turbine first-stage disk 1 and the rear-side end surface of the spacer 8. Since the spacer 8 is fitted to the distant piece 7 through the bolt joint and the spigot portions 7d and 8d, a seal 14 is provided on the fin 13 having a contact surface with the turbine first-stage disk 1. As this seal 14 can be used, such as, an “O” ring seal, for an example.

The cooling air passes through an inner periphery side of the distant piece 7, and it is guided into the cavity 8a from the joint portion 11. The cooling air flowing into the cavity 8a is guided to the respective blades of the first-stage rotor blades 5. A cooling hole 12 is machined in the turbine first-stage disk 1 in the same number of pieces of the rotary blades of the rotor impeller. For sending the cooling air into the rotary blades, the pressure within the cavity 8a must be kept at an appropriate value. If the sealing is bad between the spacer 8 and the turbine first-stage disk 1, a portion of the cooling air leaks therefrom, and then the cooling air comes to be in short for the rotary blades.

Further, on the rotor as the rotary body, the centrifugal forces act depending upon the mass and the rotary speed thereof. Namely, if the spacer 8 has a complicated shape, a considerable stress acts on a corner or the like of the spacer 8. Then, for avoiding from such the stress concentration, according to the present embodiment, the spacer 8 is attached on the side of the distant piece 7, thereby achieving both the sealing property and ensuring the reliability thereof. However, there is no necessity of attaching a seal member on the turbine first-stage disk 1, also the property can be improved, in particular, in assembling thereof. Further, since no joint is made between the turbine first-stage disk 1 and the spacer 8, there is no necessity of removing the spacer 8 from the distant piece 7 even if disassembling the turbine first-stage disk 1, thereby improving also the maintenance property thereof. Also, since it is hardly needed to remove the spacer 8 from the distant piece 7, therefore no fitting, such as, the tight fit, for example, nor the special structure is required for the attachment of the spacer 8 onto the distant piece 7, therefore it is enough with the spigot joint having actual past records.

In the present embodiment, the distant piece and the spacer are made from separate materials, respectively, therefore it is necessary to make an evaluation on the strength in advance, in particular, on the contact stress at the spigot portion and/or on the stress at the bolt hole, in the stage of designing. However, this evaluation on the strength is not necessary if the distant piece and the spacer are made from the same material. In the present embodiment, a special joint is adopted at the connection portion between the distant piece and the rotor, and therefore, from a viewpoint of machining of the joint, the distant piece and the spacer are made from the separate materials.

As is shown in FIG. 2, the vertical cross-section configuration (in the radius direction thereof) of the spacer 8 is made up, so that the surface opposing to the turbine first-stage disk 1 lies perpendicular to the rotation shaft of the turbine. If making the cross-section configuration of this spacer 8 into a corn-like shape, so that it inclines to a side of the turbine first-stage disk 1, it is not necessary to provide the fin 13 on the turbine first-stage disk 1. However, the spacer 8 is the rotary body, and bending stress applies on the spacer 8 due to the centrifugal forces caused by the spacer 8 per se. Then, for bringing the bending stress to be small, the distance in the turbine shaft is made short, from the bolt joint portion with the distant piece 7 up to the seal surface by means of the seal member 14. Also, the plate thickness of the seal member 8 is made thin, in particular, at the portion 8a projecting into an outer diameter side thereof, where the seal surface is formed, comparing to that of the periphery portion of the seal member 14, which lies in an inner side than this projection portion. The spacer used in the present embodiment is a hollow rotary body, and the centrifugal forces applied thereon come to the maximum at the central hole thereof. Accompanying this, the stress at an edge of the screw hole has also importance. Thus, the larger the masses on the outer diameter side, the greater the centrifugal stress applying at the central hole. Then, according to the present embodiment, the plate thickness is made thin on the outer periphery side, thereby achieving reduction of the centrifugal stress applied thereon.

Further, according to the present embodiment, the turbine first-stage disk, the turbine second-state disk, the distant piece, and the rotor portion of the compressor are stuck on a center of the rotary shaft, however it is also possible to apply the spacer according to the present embodiment, if no such the central hole is formed in the turbine disks. An example thereof is shown in FIG. 4. This FIG. 4 is the vertical cross-section view of the connection portion between a distant piece 107 and a turbine first-stage disk 101 and a turbine second-stage disk 102, for showing only principle portions thereof. The method for attaching the spacer 108 onto the distant piece 107 is same to that shown in the embodiment mentioned above. Thus, a cavity 108a is formed, and a fin 113 is formed on the turbine first-stage disk 101, contacting on the seal member. No such the central hole is formed in the turbine first-stage disk 101, but through holes for stacking bolts 109 are formed at plural positions in the peripheral direction, in a middle portion of the radial direction thereof. In this case, the bolt positions must be designed appropriately on the basis of the centrifugal stress thereon. However, in the similar manner to the embodiment mentioned above, there is no necessity of attaching the seal member on a side of the turbine disk, therefore assembling ability of the rotor can be improved.

In each the embodiment mentioned above, the explanation was given on the gas turbine having two (2) stages of the gas turbines, however it is needless to say that the present spacer and the structure of the cavity can be also applied if the number of the turbine stages is three (3) or more than that. Also, for the stationary blades, it is sufficient to use the cooling method in accordance with the conventional art.

As was fully explained in the above, according to the present invention, in the gas turbine, in which the distant piece and the turbine first-stage disk are connected by means of the joint portion, since the cavity is formed by the spacer member fixed onto the distant piece, therefore sealing can be achieved certainly between the cooling air and the combustion gas, with the simple structure.

What is claimed is:

1. A gas turbine, comprising:
a turbine having a plural number of rotary blades attached on a disk;
a compressor; and
a distant piece for connecting between said turbine and said compressor, whereby a portion of compression air compressed in said compressor is used for cooling the rotary blades of said turbine,
wherein a spacer member is attached on one end of said distant piece, in axial direction thereof, for forming a cooling passage by means of the compression air between said disk.

2. A gas turbine, as described in the claim 1, further comprising a seal member provided for sealing between said spacer member and said disk.

3. A gas turbine, comprising:
a turbine having a plural number of rotary blades attached on a disk;
a compressor; and
a distant piece for connecting between said turbine and said compressor, wherein a portion of compression air compressed in said compressor is used for cooling the rotary blades of said turbine,
wherein said disk has a ring-like fin extending into a side of said compressor on a periphery side being inner than implantation portions of the rotary blades; a spacer member is provided at an end portion of said distant piece at a side of the turbine; and a cavity is formed between said distant piece and said disk by bringing said fin and said spacer member into contact with.

4. A gas turbine, as described in the claim 3, wherein said disk has a plural number of cooling holes, being formed at a distance therebeteween in a direction of periphery thereof, and those cooling holes are connected to said cavity and said rotary blades.

5. A gas turbine, as described in the claim 3, wherein other cooling holes are provided for guiding a portion of the gas compressed in said compressor into said cavity.

6. A gas turbine, as described in the claim 4, wherein said turbine is made up with a plural number of stages, and said cooling holes are formed only in a disk of a first-stage thereof.

7. A gas turbine, as described in the claim 5, wherein said turbine is made up with a plural number of stages, and said cooling holes are formed only in a disk of a first-stage thereof.

8. A gas turbine, as described in the claim 3, wherein a cooling passage is formed in said rotary blade, connecting to said cooling hole.

9. A gas turbine, as described in the claim 4, wherein a cooling passage is formed in said rotary blade, connecting to said cooling hole.

10. A gas turbine, as described in the claim 5, wherein a cooling passage is formed in said rotary blade, connecting to said cooling hole.

11. A spacer member, being fixedly attached on an end portion of a distant piece for connecting a compressor and a turbine, comprising a cavity formed between said distant piece and a disk for use of turbine rotary blades.

12. A spacer member, as described in the claim 11, wherein said spacer member is disposed so that an end surface thereof is in contact with a ring-like fin, being formed on said disk for use of turbine rotary blades in an inner side than implanting portion of the rotary blades thereof and extending into a side of said compressor, through a seal member.

13. A spacer member, as described in the claim 12, wherein the side end surface at the compressor is a plane when said spacer member is fixed onto said distant piece, and thickness in axial direction of a portion contacting with the ring-like fin formed on said disk for use of turbine rotary blades is thinner than that in axial direction of a portion connecting to said distant piece.
